(19) United States
(12) Patent Application Publication
(10) Pub. No.: US 2011/0082820 A1
(43) Pub. Date: Apr. 7, 2011

(54) ASSESSING AN ENVIRONMENTAL FOOTPRINT OF AN OBJECT

(76) Inventors: Amip J. Shah, Palo Alto, CA (US); Denlee Gomes, Cupertino, CA (US)

(21) Appl. No.: 12/574,303

(22) Filed: Oct. 6, 2009

(51) Int. Cl. G06F 15/18; G06Q 10/00; G06Q 50/00; G06N 5/02

(52) U.S. Cl. 706/12; 706/54; 705/7.11; 705/308

(57) ABSTRACT

In a method for assessing an environmental footprint of an object, economic data and environmental data of the object is aggregated and complexity of the object is determined. In addition, the economic data, the environmental data, and the complexity of the object are correlated and a model of an environmental footprint of the object is created based upon the correlation. Moreover, the environmental footprint of the object is assessed through application of the model.

### CROSS-REFERENCE TO RELATED DISCLOSURE

The present application shares some common subject matter with commonly assigned and copending U.S. patent application Ser. No. 12/353,104 filed on Jan. 13, 2009, and U.S. patent application Ser. No. 12/254,571 filed on Oct. 20, 2008, which claims priority to U.S. Provisional Patent Application Ser. No. 60/990,438 (Attorney Docket No. 200702978-1), filed on Nov. 27, 2007, the disclosures of which are hereby incorporated by to reference in their entireties.

### BACKGROUND

There has been increasing focus on reducing the environmental impact of many products due to ever increasing concerns over the detrimental effects on human health and on the environment. One way to measure the environmental impact of a product is to evaluate the environmental impact of the product through an approach known as life-cycle assessment (LCA), which considers a product across its entire life-cycle from extraction of raw materials, through manufacturing processes, transportation, operation, and end of life recycling or disposal. Conventional LCA methods use numerous variables, which may also include economic input and output (EIO) variables. The input variables often include hundreds, if not thousands of materials, processes, and related data, such as, mass and energy consumption. The output variables often include one or more environmental impact, such as, greenhouse gas emissions, resource consumption, toxicity, and health damage.

Often, given a particular LCA, it is not intuitive to a product designer as to how the product attributes (input variables) are to be modified to reduce the environmental impact of a product (output variables). As such, designers are currently required to iteratively attempt multiple configurations for the products and to re-run the LCA on the multiple configurations to evaluate whether the iterated design has successfully reduced the environmental impact of the product. This is often a time consuming and laborious process for the designer because of the large number of possible input variables, and often may not lead to a feasible solution even after multiple iterations are performed.

### BRIEF DESCRIPTION OF THE DRAWINGS

Features of the present invention will become apparent to those skilled in the art from the following description with reference to the figures, in which:

FIG. 1 shows a simplified block diagram of a system for assessing an environmental footprint of an object, according to an embodiment of the invention;

FIG. 2 illustrates a flow diagram of a method of assessing an environmental footprint of an object, according to an embodiment of the invention;

FIG. 3 illustrates a flow diagram of a method of validating the assessed environmental footprint of the object in the method illustrated in FIG. 2, according to an embodiment of the invention; and

FIG. 4 shows a block diagram of a computing apparatus configured to implement or execute the environmental footprint assessment tool depicted in FIG. 1, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are a system and method of assessing an environmental footprint of an object. As disclosed herein, economic and environmental data of an object are aggregated and correlated. In addition, a model of the environmental footprint of the object based upon the correlations between the economic data and the environmental data of the object is created and one or more of the economic data and the environmental data of the object are manipulated to assess the environmental footprint of the object based upon the model.

Through implementation of the methods and systems disclosed herein, existing economic and environmental data may be employed to assess an environmental footprint of an object. As used herein, an object may include any arbitrary product, system, or ecosystem, and may include a product employed in performing a process or providing a service. As such, the methods and systems disclosed herein may enable an environmental footprint of an object to be assessed expeditiously. In addition, the methods and systems disclosed herein enable a relatively large number of variables to be inventoried and modeled concurrently, which generally improves assessment of the environmental footprint of an object. The variables include the economic and environmental data associated with one or more aspects of the object. In one regard, the improved environmental footprint assessment may be employed to reduce the environmental footprint of the object.

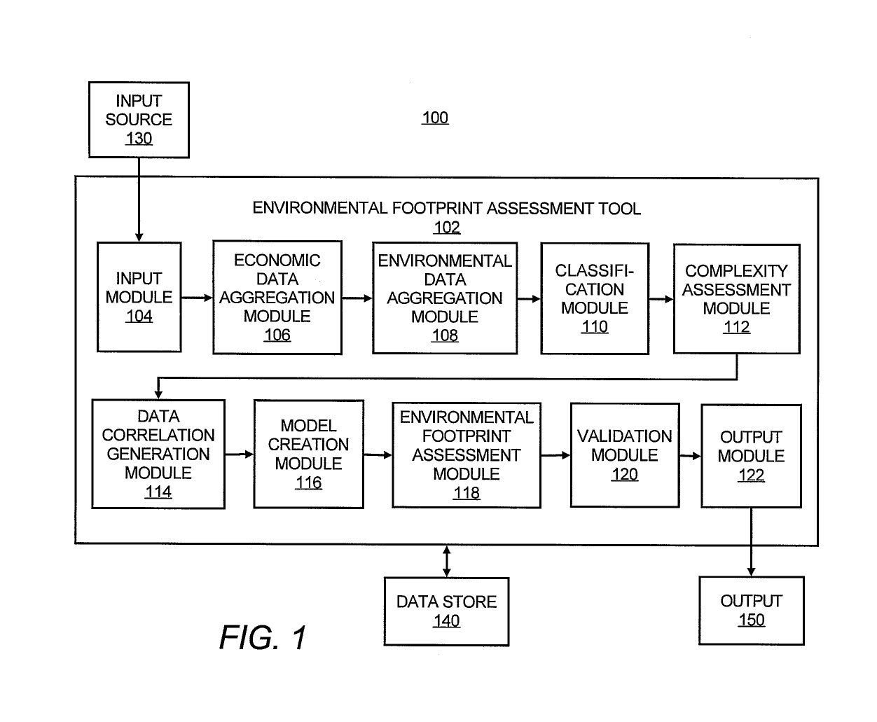

With reference first to FIG. 1, there is shown a simplified block diagram of a system 100 for assessing an environmental footprint of an object, according to an example. It should be understood that the system 100 may include additional elements and that some of the elements described herein may be removed and/or modified without departing from a scope of the system 100.

As shown, the system 100 includes an environmental footprint assessment tool 102, which may comprise software, firmware, and/or hardware and is configured to assess an environmental footprint of an object. According to an example, the environmental footprint assessment tool 102 may comprise a plug-in module for use with another software tool.

The object may comprise any physical product or group of products that are manufactured through consumption of resources. The object may also comprise any physical product or group of products used in providing one or more services. In addition, the environmental footprint may represent one or more environmental impact, such as, sustainability, exergy destruction, energy consumption, etc., economic data, such as, cost, manufacturing time, finishing requirements, etc., and the like.

In any regard, the environmental footprint assessment tool 102 is depicted as including an input module 104, an economic data aggregation module 106, an environmental data aggregation module 108, a classification module 110, a complexity assessment module 112, a data correlation generation module 114, a model creation module 116, an environmental footprint assessment module 118, a validation module 120, and an output module 122. In instances where the environmental footprint assessment tool 102 comprises software, the environmental footprint assessment tool 102 may be stored on a computer readable storage medium and may be executed by the processor of a computing device (not shown). In these instances, the modules 104-122 may comprise software modules or other programs or algorithms configured to perform the functions described herein below. In instances where the environmental footprint assessment tool 102 comprises firmware and/or hardware, the environmental footprint assessment tool 102 may comprise a circuit or other apparatus configured to perform the functions described herein. In these instances, the modules 104-122 may comprise one or more of software modules and hardware modules configured to perform these functions.

In any regard, the environmental footprint assessment tool 102 may be executed or implemented to assess an environmental footprint of an object. The object may include a product or a system, such as, an electronic apparatus including a desk top computer, a laptop computer, a server, a personal digital assistant, a printer, air conditioning unit components, etc., or a combination of multiple products and systems, such as, servers on an electronics cabinet, an IT data center, a print to factory, an air conditioning system, etc. Other types of products include, for instance, chalkboard erasers, pens, engines, compressors, etc. The products may further be components of systems, such as, automobiles, aircrafts, ships, etc. The object may also be employed in providing a service, such as digital data transmission service that requires at least a data server and data storage as objects employed in the performance of the service, and consumes electricity energy. The service may also include other services that are needed to support the service, such as infrastructure setup service, which may include a cable installation service in the digital data transmission service example. Various examples of manners in which the environmental footprint assessment tool 102 may assess an environmental footprint of individual and multiple objects are described herein below.

As shown in FIG. 1, the input module 104 is configured to receive input from an input source 130. The input source 130 may comprise a computing device, through which economic and environmental data may be inputted into the environmental footprint assessment tool 102. The environmental footprint assessment tool 102 and the input source 130 may form part of the same computing device or different computing devices. The inputted economic and environmental data may include, for instance, economic and environmental information pertaining to at least one stage in a lifecycle of the object to be assessed. The stages of the lifecycle of the object include, for instance, creation, implementation, and disposal/re-use. At the creation or fabrication stages, there are a number of parameters (or variables) that may be modified, which affects a plurality of output metrics of the object during its lifecycle.

By way of example, at the creation or fabrication stage, the different types of materials, suppliers of materials, transportation options of receiving the materials, processing operations of the materials, etc., are all different parameters (variables) that may be modified. In addition, selection of various types of materials and processes employed to extract, fabricate, and construct the object using the various types of material and processes affect a number of various metrics in different ways. For instance, a first type of material may require a great deal of manpower to obtain and fabricate, whereas a second type of compatible material may be easier to obtain and fabricate. However, during implementation of the at least one system, the first type of material may require a greater amount of energy or have a larger carbon footprint than the second type of material.

The inputted economic and environmental data may also include various other information pertaining to the parameters (variables) of the materials and processes that affect the object. The other information may include, for instance, the amount of energy required to fabricate the materials, the amount of time required to collect and manipulate the materials, information pertaining to the compatibility or the ability to substitute materials and/or processes for each other, etc. The other information may also include, for example, various environmental impacts of the various materials and processes, such as, exergy destruction values associated with the various materials, carbon footprints associated with the fabrication and/or use of the various materials and processes, etc.

By way of particular example, the inputted economic and environmental data may include exergy destruction values associated with each of a plurality of candidate materials. The exergy destruction values may be based upon the amount of exergy destroyed during respective extraction and/or fabrication processes of the candidate materials. In addition, or alternatively, the exergy destruction values may be based upon the amount of exergy destroyed during respective disposal processes of the candidate materials. In addition, the exergy destruction values may also be based upon the ability to re-use or reclaim the exergy destroyed during implementation and/or disposal of the candidate materials. The exergy destruction values may further be based upon the amount of exergy destroyed in the respective supply chains associated with the candidate materials. In one regard, therefore, the exergy destruction values may be based upon one or more stages in the respective life cycles of the candidate materials. The respective life cycles may include extraction, fabrication, use, disposal, and re-use of the candidate materials. Examples of manners in which exergy destruction values may be determined are described in the Ser. No. 12/254,571 application for patent.

The inputted economic and environmental data may further include environmental impacts and/or economic values, such as, cost, manufacturing time, finishing requirements, etc., associated with the object during or after it has been fabricated using various types of materials and/or processes. The environmental impacts and/or economic values may be based upon various stages of the at least one system lifecycle, such as, during one or more of the fabrication, transportation, use, disposal, and re-use processes.

Additional factors that may be considered in assessing an environmental footprint of the object are presented herein below.

In one example, the environmental footprint assessment tool 102 may be programmed to perform calculations to determine the environmental impacts and/or the economic values. In this example, the environmental footprint assessment tool 102 may be configured to employ one or more models or techniques in determining the environmental footprint of the object. In another example, the environmental impact calculations and/or the economic values of the materials and/or processes may be performed through implementation of an environmental footprint assessment model by an external computing apparatus and the information may be fed into the environmental footprint assessment tool 102.

According to an example, the input module 104 may provide a graphical user interface through which a user may provide instructions or input information into the environmental footprint assessment tool 102. The input module 104 may also provide an interface through which a user may supply a required input for the environmental footprint assessment tool 102 to achieve a desired output. By way of particular example, the user may employ the input module 104 to instruct the environmental footprint assessment tool 102 to assess an object that has at least one of a minimal carbon footprint, a carbon footprint that falls below a particular value, etc.

The environmental footprint assessment tool 102 may store the data received from the input source 130 and the user in a data store 140, which may comprise volatile and/or non-volatile memory, such as DRAM, EEPROM, MRAM, flash memory, and the like. In addition, or alternatively, the data store 140 may comprise a device configured to read from and write to a removable media, such as, a floppy disk, a CD-ROM, a DVD-ROM, or other optical or magnetic media.

The economic data aggregation module 106 is configured to aggregate economic data of the object, and may thus include identification of a number of variables that may not affect the assessment of an environmental footprint of an object. The economic data of the object may correspond to the economic value of the object, such as the price of the object, but may also include additional data, such as costs, margins, discount rates, attach rates etc. Information regarding sub-components of the object may also be aggregated in the economic data aggregation module 106. The economic data of the object may be collected from public sources, such as commodity markets and publicly traded markets, but may also include proprietary (internal) data.

According to an example, the economic data aggregation module 106 may identify the plurality of variables based upon information inputted into the environmental footprint assessment tool 102 by a user. According to another example, the economic data aggregation module 106 may aggregate the plurality of variables from one or more databases that contain information pertaining to economic data for different materials and/or processes that may be employed to fabricate the object. According to a further example, the economic data aggregation module 106 may aggregate the plurality of economic data variables among an initial listing of variables by identifying other variables, from a database, for instance, that are suitably compatible with the initial listing of variables. In any regard and by way of particular example to the object comprising a computing device, the economic data aggregation module 106 may aggregate different costs of plastic or other materials, such as, aluminum, that may be suitable for use in forming a casing of the computing device.

The environmental data aggregation module 108 is configured to aggregate environmental data of the object, and may thus include identification of a number of variables that may affect the assessment of an environmental footprint of an object. The environmental data of the object may be publicly available data regarding the object to be assessed. The environmental data of the object may correspond to any type of environmental impact, such as carbon, exergy, energy, toxicity, etc. Information regarding sub-components of the object may also be is aggregated in the environmental data aggregation module 108. The environmental data aggregation module 108 may aggregate and utilize whatever data are available easily to generate preliminary models with the goal of accelerating the convergence process. In addition, it is not necessary that the environmental data collected pertain directly to the object. For example, if the environmental footprint of a laptop computer is of interest, the environmental data aggregation module 108 may aggregate existing environmental data regarding the environmental footprint of its component material sets, such as aluminum and types of plastics. The remaining modules, as discussed in greater detail herein below, may address missing pieces of environmental data. The environmental data may be collected through an automated process, such as a process based on Internet searches or user-driven data collection, or from existing databases.

According to an example, the environmental data aggregation module 108 may aggregate the plurality of variables from one or more databases that contain information pertaining to environmental data for different materials and/or processes that may be related to the object. According to a further example, the environmental data aggregation module 108 may aggregate the plurality of environmental data variables among an initial listing of variables by identifying other variables from a database, for instance, that are suitably compatible with the initial listing of variables. In any regard, and by way of particular example to the object comprising a computing device, the environmental data aggregation module 108 may aggregate different environmental impacts of plastic or other materials, such as, aluminum, that may be suitable for use in forming a casing of the computing device.

The classification module 110 is configured to classify the aggregated economic data and environmental data based on a type of the object. After aggregating the economic data and environmental data, the economic data and environmental data may also further be classified depending on certain object attributes. In one example, a hierarchical structure may be utilized where economic data related to an object is stored together and economic data related to components of the object is stored together. In another example, similar types of objects may be stored together, for instance, all commodities are placed in one tree structure and all organic materials are placed in another tree structure. Alternatively, more intelligent allocation techniques, such as data mining, may be used to discover inherent patterns in the aggregated data, with the categorization, accordingly. Optionally, the classification module 110 may be a part of the economic data aggregation module 106 or the environmental data aggregation module 108.

The complexity assessment module 112 is configured to assess the complexity of the object. According to a particular example, the complexity assessment module 112 may assess the complexity of the object using a metric from information theory. According to other examples, the complexity assessment module 112 is configured to employ other types of metrics in assessing the complexity of the object.

The data correlation generation module 114 is configured to select an appropriate type of correlation (or model) based upon the complexity of the object, as discussed in greater detail herein below. For a simple object, such as a single material like aluminum, which relies heavily on material and energy consumption in its creation, simplistic relationships (for instance, linear) may be likely to adequately capture the environmental and economic dependence. However, for more complex objects, such as laptop computers, which involve numerous external factors beyond the direct material and energy consumption both environmentally and economically, more sophisticated relationships (for instance, multi-part piecewise models) may be required. Additional methods to assess the complexity of the object may include a method that depends on the total number of components involved in creating the object, the volatility associated with an economic value of the object, etc.

The data correlation generation module 114 is configured to correlate the economic data and the environmental data of the object with the assessed complexity of the object. The data correlation generation module 114 utilizes the economic data, environmental data, and the complexity of the object to identify key dependencies and/or relationships between each set of data. For example, an arbitrary dependency between different types of materials at the same complexity level may be identified. These relationships may be generated through manual inspection, automatically through a data mining algorithm, via a look-up table with key parameter listings, or through trial-and-error computational models. The data correlation generation module 114 may also use previously known relationships to guide this relationship generation. For example, the data correlation generation module 114 may use a relationship between existing materials to derive the relationships between new materials as well. As the amount of data and relationships stored increase, the accuracy and speed with which the relationships are created will also improve over time.

The model creation module 116 is configured to create a model of an environmental footprint of the object based upon the correlations between the economic data, the environmental data, and the complexity of the object. The model is configured to be implemented in predicting or assessing the environmental footprint of the object. Generally, the model creation module 116 is configured to create a model of the input and output correlations of the plurality of variables. According to an example, the model creation module 116 may create a relatively simple model by summing the enviro-economic correlations for all of the sub-components of the object. According to another example, the model creation module 116 may create the model to be more advanced, such as, by utilizing different criteria for each of the sub-components, each of a plurality of relationships between the sub-components, etc. In addition, the model creation module 116 may implement rule-based or inference-based engines in creating the model. As another example, the model creation module 116 may generate the model through manual inspection, automatically through a data mining algorithm, via a look-up table with key parameter listings, or through trial-and-error computational models.

According to an embodiment, the model creation module 116 is configured to create the model by commissioning the plurality of variables from initial economic and environmental data of the object. The plurality of variables comprise the economic data and the environmental data of the object. The model creation module 116 performs the commissioning process to determine how one or more metrics (environmental footprints) are impacted when the input variables (economic and environmental data) are modified. The corresponding impacts may comprise, for instance, one or more environmental impact resulting from the initial settings of the variables. Thus, by way of particular example, the commissioning process is employed to determine how a change in the volume of a particular material changes greenhouse emissions.

In any regard, the model creation module 116 may perform the commissioning process on the plurality of variables to develop correlations between the various economic and environmental data variables and the resulting impacts on the environmental footprint of the object. According to an example, the model creation module 116 is configured to perform the commissioning process by sequentially perturbing one variable from the initial economic and environmental data at a time and determining an impact resulting from the perturbations. In this example, the model creation module 116 may determine the impact resulting from, for instance, substituting one or more of the economic and environmental data with each of a number of known comparable economic and environmental data.

According to a further example, instead of perturbing each of the variables, the model creation module 116 may perturb selected ones of the variables to thereby reduce the amount of time required to create the model. In one example, the model creation module 116 may perturb only those variables that have been identified as being independent variables. Independent variables comprise those variables that are not affected by changes to other variables and dependent variables comprise those variables that change when at least one other variable is modified. In another example, the model creation module 116 may prioritize the independent variables to determine which of the independent variables are to be perturbed first. In this example, for instance, the independent variables may be prioritized in accordance with the ease, for instance, in practical or cost effective perspective, in which the independent variables may be modified. Thus, for instance, those independent variables that are more easily changed may be perturbed before those independent variables that are more difficult to change.

According to another example, the independent variables may be variously prioritized until an absolute or relative change in the impact resulting from the variously prioritized independent variables is noticed. For instance, the independent variables may be prioritized in accordance with a percentage (%) change of an output that each of the independent variables may cause in the output and only those variables that cause more than a predetermined percentage (%) change in the output may be used. As another example, the model creation module 116 may perturb only a predetermined number of the top priority independent variables to reduce the amount of time required to create the model.

The model creation module 116 may further be configured to aggregate correlations between the economic data and the environmental data of one or more components of the object, and to create one or more sub-models of the environmental footprint for the one or more components of the object. In addition, the model may be implemented in an iterative scheme to enable a user to initially input a relatively small number of economic and environmental data values and to input additional economic and environmental data values as required for the model to output sufficiently accurate environmental footprint assessments.

The environmental footprint assessment module 118 is configured to assess the environmental footprint of the object through application of the model created by the model creation module 116. More particularly, for instance, the environmental footprint assessment module 118 is configured to apply the model, which is configured to specify the required inputs and the desired outputs and, upon receipt of the required inputs, to identify the desired environmental footprint. According to a particular example, the input to the model comprises economic value data of the object and the output from the model comprises a corresponding environmental footprint. In determining the corresponding environmental footprint, the environmental footprint assessment module 118 may be configured to perform an iterative operation, beginning with a relatively small number of inputs and expanding the number of inputs as required to identify sufficiently accurate environmental footprint assessments. In one regard, the iterative operation may maintain a minimal cost for creating and running the model.

The validation module 120 is configured to validate the assessed environmental footprint of the object by calibrating the assessed environmental footprint against a known environmental footprint of a second object. The second object may be a similar object to the object being assessed. The validation module 120 is further configured to periodically calibrate the model created by the model creation module 116 within a predetermined time interval using newly available economic and environmental data of the object to improve an uncertainty range for the model. The validation module 120 is also configured to specify an uncertainty range for the model based on a difference between a predicted environmental footprint from the model and the known environmental footprint of the second object. The validation module 120 is further configured to iteratively validate the assessed environmental footprint of the object to improve the uncertainty range for the model, and to determine a qualification of the assessed environmental footprint using the uncertainty range for the model.

The output module 122 is configured to output the assessment of the environmental footprint of the object to an output 150. The output 150 may comprise, for instance, a display configured to display the identified environmental footprint of the object. In addition, or alternatively, the output 150 may comprise a fixed or removable storage device on which the identified environmental footprint of the object is stored. As a further alternative, the output 150 may comprise a connection to a network over which the identified environmental footprint of the object may be communicated.

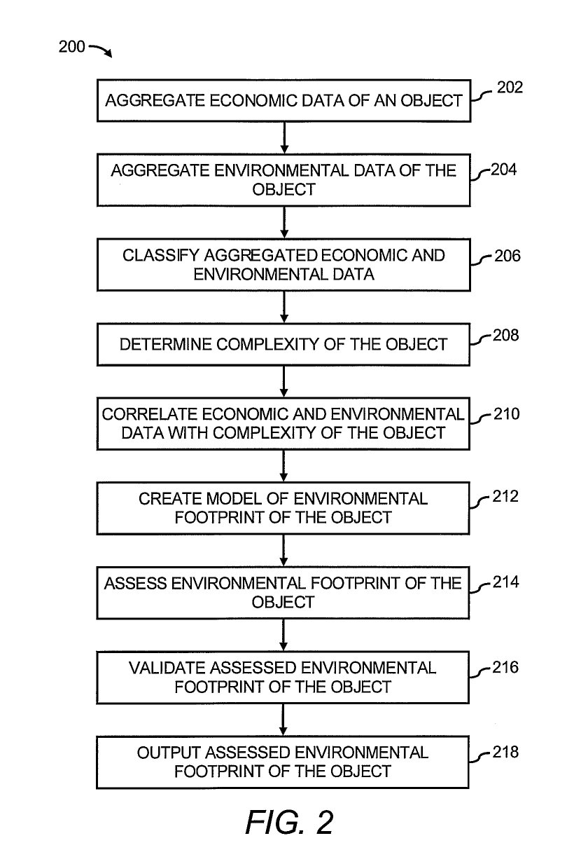

An example of a method in which the system 100 may be employed to assess an environmental footprint of an object will now be described with respect to the following flow diagram of the method 200 depicted in FIG. 2, which is directed to a method of assessing an environmental footprint of an object, according to an example. It should be apparent to those of ordinary skill in the art that the method 200 represents a generalized illustration and that other steps may be added or existing steps may be removed, modified or rearranged without departing from a scope of the method 200.

The description of the method 200 is made with reference to the system 100 illustrated in FIG. 1, and thus makes reference to the elements cited therein. It should, however, be understood that the method 200 is not limited to the elements set forth in the system 100. Instead, it should be understood that the method 200 may be practiced by a system having a different configuration than that set forth in the system 100.

A controller, such as a processor (not shown), may implement or execute the environmental footprint assessment tool 102 to perform one or more of the steps described in the method 200.

At step 202, the economic data aggregation module 106 aggregates economic data of the object. A user may input the economic data of the object into the environmental footprint assessment tool 102 or the economic data aggregation module 106 may aggregate economic data of the object from information contained in one or more databases.

At step 204, the environmental data aggregation module 108 aggregates environmental data of the object. According to an example, the environmental data aggregation module 108 aggregates the plurality of variables from one or more databases that contain information pertaining to environmental data for different materials and/or processes that may be related to the object. In addition, the inventory creation module 108 further aggregates information regarding sub-components of the object.

At step 206, the classification module 110 may optionally classify the aggregated economic data and environmental data based on a type of the object. As discussed above, after aggregating the economic data and environmental data, the economic data and environmental data may also further be classified depending on certain object attributes to discover inherent patterns in the aggregated data. In addition, or alternatively, the classification module 110 may classify the aggregated economic data and environmental data to enable the data to be more easily retrieved at a later time.

At step 208, the complexity assessment module 112 assesses a complexity of the object. As discussed above, examples of methods to assess the complexity of the object may include but are not limited to a method that depends on the total number of components involved in creating the object, and the economic value of the object.

At step 210, the data correlation generation module 114 correlates the economic data, the environmental data, and the complexity of the object. According to an example, once the economic and environmental data have been aggregated and the system complexity has been assessed, the data correlation generation module 114 utilizes the economic data, the environmental data, and the complexity of the object to identify key dependencies and/or relationships between each set of data.

At step 212, the model creation module 116 creates a model of an environmental footprint of the object based upon the correlations between the economic data, the environmental data, and the complexity of the object. The model creation module 116 may create a model of the input and output correlations of the plurality of variables by commissioning the plurality of variables from the initial values. The plurality of variables represents the economic data and the environmental data of the object.

At step 214, the environmental footprint assessment module 118 assesses the environmental footprint of the object by identifying values for the plurality of variables through application of the model created by the model creation module 116 at step 212, and by manipulating one or more of the economic data and the environmental data of the object through application of the model.

At step 216, the validation module 120 validates the assessed environmental footprint of the object by calibrating against a second object having a known environmental footprint. As discussed above, the second object may be a similar object to the object being assessed its environmental footprint.

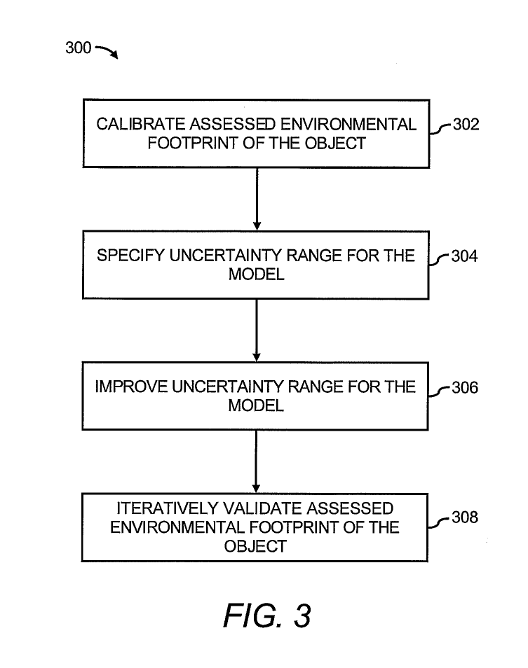

Turning now to FIG. 3, there is shown a flow diagram of a method 300 of validating the assessed environmental footprint of the object in the method 200 illustrated in FIG. 2, according to an example. FIG. 3, more particularly, depicts a method 300 of validating the assessed environmental footprint of the object. As such, the method 300 depicts step 216 in FIG. 2 with greater specificity, according to an embodiment.

At step 302, the validation module 120 calibrates the assessed environmental footprint of the object against a second object having a known environmental footprint. The second object may be similar in one or more respects to the object being assessed.

At step 304, the validation module 120 specifies the uncertainty range for the model based on a difference between a predicted environmental footprint from the model and the known environmental footprint of the second object.

At step 306, the validation module 120 periodically calibrates the model created by the model creation module 116 within a predetermined time interval using newly available economic and environmental data of the object to improve an uncertainty range for the model.

At step 308, the validation module 120 iteratively validates the assessed environmental footprint of the object to improve the uncertainty range for the model, and to determine a qualification of the assessed environmental footprint using the uncertainty range for the model.

In any regard, at step 218, the output module 122 outputs an assessed environmental footprint of the object. In certain instances, however, the environmental footprint assessment module 118 may be unable to determine an environmental footprint of the object. In these instances, the output module 122 may output an indication that the environmental footprint has not been assessed at step 218. In response, the environmental footprint assessment tool 102 may receive further variables and/or a modified economic and environmental data from a user and the environmental footprint assessment tool 102 may repeat the method 200 based upon the further variables and/or modified economic and environmental data.

The process described above may also be similarly repeated for multiple data variables, for instance, amount of plastic, processor power consumption, etc., as well as for multiple metrics, for instance, carbon footprint, cost-of-ownership, processing speed, etc. In addition, the process described above may also be extended beyond just a single product to span sets of products, systems or even ecosystems. In this manner, through implementation of the method and system disclosed herein, a system to assess an environmental footprint of an object may be constructed.

In addition, although not shown in the method 200, the environmental footprints of various objects may be assessed to identify objects that have minimized environmental footprints. In another example, the environmental footprint of the object using different materials or processes may be assessed through implementation of the method 200 to identify one or more materials and/or processes that result in a minimized environmental footprint for the object.

Some or all of the operations set forth in the methods 200 and 300 may be contained as a utility, program, or subprogram, in any desired computer accessible medium. In addition, the methods 200 and 300 may be embodied by computer programs, which can exist in a variety of forms both active and inactive. For example, they may exist as software program(s) comprised of program instructions in source code, object code, executable code or other formats. Any of the above may be embodied on a computer readable medium, which include storage devices.

Exemplary computer readable storage devices include conventional computer system RAM, ROM, EPROM, EEPROM, and magnetic or optical disks or tapes. Concrete examples of the foregoing include distribution of the programs on a CD ROM or via Internet download. It is therefore to be understood that any is electronic device capable of executing the above-described functions may perform those functions enumerated above.

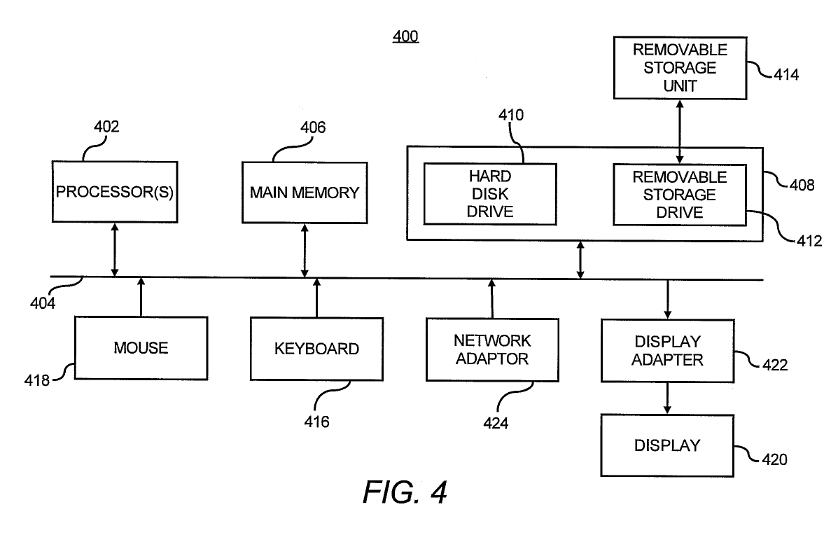

FIG. 4 illustrates a block diagram of a computing apparatus 400 configured to implement or execute the environmental footprint assessment tool 102 depicted in FIG. 1, according to an example. In this respect, the computing apparatus 400 may be used as a platform for executing one or more of the functions described hereinabove with respect to the environmental footprint assessment tool 102.

The computing apparatus 400 includes a processor 402 that may implement or execute some or all of the steps described in the methods 200 and 300. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more hard disk drives 410 and/or a removable storage drive 412, representing a floppy diskette drive, a magnetic tape drive, a compact disk drive, etc., where a copy of the program code for the methods 200 and 300 may be stored.

The removable storage drive 410 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor 402 and convert the display data into display commands for the display 420. In addition, the processor(s) 402 may communicate over a network, for instance, the Internet, LAN, etc., through a network adaptor 424.

It will be apparent to one of ordinary skill in the art that other known electronic components may be added or substituted in the computing apparatus 400. It should also be apparent that one or more of the components depicted in FIG. 4 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. A method for assessing an environmental footprint of an object, said method comprising steps performed by a processor of:
aggregating economic data of the object;
aggregating environmental data of the object;
determining complexity of the object;
correlating the economic data, the environmental data, and the complexity of the object;
creating a model of an environmental footprint of the object based upon the correlation; and
assessing the environmental footprint of the object through application of the model.

2. The method according to claim 1, wherein the object is formed of a plurality of components, said method further comprising:
classifying the aggregated economic data and environmental data into a plurality of categories based on the plurality of components of the object.

3. The method according to claim 1, further comprising:
validating the assessed environmental footprint of the object.

4. The method according to claim 3, further comprising:
periodically calibrating the model within a predetermined time interval using newly available economic and environmental data of the object to improve an uncertainty range for the model.

5. The method according to claim 3, further comprising:
specifying an uncertainty range for the model based on a difference between a predicted environmental footprint from the model and the known environmental footprint of the second object; and
iteratively validating the assessed environmental footprint of the object to improve the uncertainty range for the model.

6. The method according to claim 5, further comprising:
determining a qualification of the assessed environmental footprint using the uncertainty range for the model.

7. The method according to claim 1, wherein determining the complexity of the object further comprises assessing a total number of components involved in creating the object and an economic value of each of the components.

8. The method according to claim 1, wherein correlating the economic data, the environmental data, and the complexity of the object further comprises:
correlating the economic data, the environmental data, and the complexity of the object using at least one of a data mining program, a look-up table with key parameter listings, through trial-and-error computational models, and a predetermined relationship between the economic data and the environmental data of the object.

9. The method according to claim 1, wherein the object comprises a plurality of components, and wherein creating a model of an environmental footprint of the object further comprises:
aggregating economic data of the plurality of components;
aggregating environmental data of the plurality of components;
determining respective complexities of the plurality of components;
correlating the economic data, the environmental data, and the complexities of the plurality of components;
aggregating the correlations of the plurality of components; and
creating sub-models of the environmental footprint for the plurality of components of the object,
wherein assessing the environmental footprint of the object further comprises assessing the environmental footprint of the object through application of the sub-models.

10. The method according to claim 1, wherein assessing the environmental footprint of the object further comprises:
inputting initial economic and environmental data of the object into the model;
applying the model to derive the environmental footprint of the object from the initial economic and environmental data of the object.

11. The method according to claim 10, wherein assessing the environmental footprint of the object further comprises:
inputting at least one additional economic and environmental data of the object into the model; and
wherein applying the model further comprises applying the model to derive the environmental footprint of the object from the at least one additional economic and environmental data of the object.

12. A computer-implemented environmental footprint assessment tool for assessing an environmental footprint of an object, said computer-implemented environmental footprint assessment tool comprising:
an economic data aggregation module configured to aggregate economic data of the object;
an environmental data aggregation module configured to aggregate environmental data of the object;
a complexity assessment module configured to determine complexity of the object;
a data correlation generation module configured to correlate the economic data, the environmental data, and the complexity of the object;
a model creation module configured to create a model of an environmental footprint of the object based upon the correlation; and
an environmental footprint assessment module configured to assess the environmental footprint of the object through application of the model.

13. The computer-implemented environmental footprint assessment tool according to claim 12, wherein the object is formed of a plurality of components, said tool further comprising:
a classification module configured to classify the aggregated economic data and environmental data into a plurality of categories based on the plurality of components of the object.

14. The computer-implemented environmental footprint assessment tool according to claim 12, further comprising:
a validation module configured to validate the assessed environmental footprint,
wherein the validation module is further configured to specify an uncertainty range for the model based on a difference between a predicted environmental footprint from the model and a known environmental footprint of a second object, and to iteratively validate the assessed environmental footprint of the object to improve the uncertainty range for the model.

15. The computer-implemented environmental footprint assessment tool according to claim 12, wherein the complexity assessment module is further configured to assess a total number of components involved in creating the object and an economic value of each of the components.

16. The computer-implemented environmental footprint assessment tool according to claim 12, wherein the data correlation generation module is further configured to correlate the economic data, the environmental data, and the complexity of the object using at least one of a data mining program, a look-up table with key parameter listings, through trial-and-error computational models, and a predetermined relationship between the economic data with the environmental data of the object.

17. The computer-implemented environmental footprint assessment tool according to claim 12, wherein the object comprises a plurality of components, and wherein the model creation module is further configured to aggregate economic data of the plurality of components, aggregate environmental data of the plurality of components, determine respective complexities of the plurality of components, correlate the economic data, the environmental data, and the complexities of the plurality of components, aggregate the correlations of the plurality of components, and create sub-models of the environmental footprint for the plurality of components of the object, wherein environmental footprint assessment module is further configured to assess the environmental footprint of the object through application of the sub-models.

18. The computer-implemented environmental footprint assessment tool is according to claim 17, wherein the complexity assessment module is further configured to determine the complexity of the object using a metric from information theory.

19. A computer readable storage medium on which is embedded one or more computer programs, said one or more computer programs implementing a method of assessing an environmental footprint of an object, said one or more computer programs comprising a set of instructions for:
aggregating economic data of the object;
aggregating environmental data of the object;
determining a complexity of the object;
correlating the economic data, the environmental data, and the complexity of the object;
creating a model of an environmental footprint of the object based upon the correlation; and
assessing the environmental footprint of the object through application of the model.

20. The computer readable storage medium according to claim 19, said one or more computer programs comprising a set of instructions for:
specifying an uncertainty range for the model based on a difference between a predicted environmental footprint from the model and a known environmental footprint of a second object; and
iteratively validating the assessed environmental footprint of the object to improve an uncertainty range for the model.
